(19) United States
(12) Patent Application Publication
(10) Pub. No.: US 2018/0111522 A1
(43) Pub. Date: Apr. 26, 2018

(54) WINDOW PILLOW

(71) Applicant: AA Corp Enterprises, Inc., East Brunswick, NJ (US)

(72) Inventors: Michael Acevedo, East Brunswick, NJ (US); Parker Christian Adamo, Millstone Township, NJ (US)

(21) Appl. No.: 15/791,302

(22) Filed: Oct. 23, 2017

Related U.S. Application Data
(60) Provisional application No. 62/411,772, filed on Oct. 24, 2016.

(51) Int. Cl. B60N 2/48

(52) U.S. Cl. CPC B60N 2/4879; A47C 7/383

(57) ABSTRACT

Embodiments relate to a pillow that can be detachably attached to a surface to provide support and comfort to a user while traveling; the pillow comprising one or more cushions; a cover that is configured to enclose the one or more cushions therein; the cushions further comprising a channel to accept a portion of the user's body; and a backing coupled to the one or more cushions to providing rigidity to the pillow.

### CROSS-REFERENCE TO RELATED APPLICATIONS

This application claims the benefit of U.S. Provisional Patent Application Ser. No. 62/411,772, filed on Oct. 24, 2016, the entire content of which is hereby incorporated by reference in its entirety.

### FIELD OF INVENTION

Embodiments of the present invention generally relate to pillows, and specifically to pillows used to support the head, shoulders, neck or other body part of a user.

### BACKGROUND

Travelling, especially for long hours, can be uncomfortable for passengers. Comfort is usually sacrificed by vehicle-makers and public transport authorities for safety, cost and space. It is a common sight to see passengers resting against the window of a vehicle during travel. Body postures resulting from attempts to rest by a passenger in a vehicle can be detrimental to the physical form of the body. It is more hazardous when there are vibrations or jolts occurring due to variable speeds and directions of travel of a moving vehicle, bumps or irregularities on a travelling surface, or air/water turbulences.

Existing state of the art includes travel pillows and headrests that can facilitate more comfortable travel. However, such pillows can be easily dislodged from under the resting body in a moving vehicle. Most of the solutions also fail to provide compact and elegant pillows that be easily mounted on a surface, such as a window. A more robust solution is necessary to provide a comfortable experience to passengers in a moving vehicle.

### SUMMARY

Embodiments of the present invention relate to a pillow designed to support the shoulders, neck and head of a user taking rest. Specifically, the pillow provides comfort when resting while travelling in vehicles, including cars, buses, trains, planes, ships and so forth.

Embodiments of the present invention provide a compact, portable and durable pillow for supporting a body part of a user during travelling. The pillow can be detachably attached to a surface to make resting and sleeping more comfortable for a user during travelling. The pillow can also include a channel to accept the head, shoulders, neck, ears or other body part of the user.

Embodiments of the present invention are related to a pillow that includes one or more cushions; a cover that is configured to enclose the one or more cushions therein; a rigid board coupled to the one or more cushions, the rigid board providing rigidity to the pillow; and at least one suction cap coupled to the rigid board or the cover, wherein the at least one suction cup is configured to detachably secure the pillow to a surface. The one or more cushions and the cover form a shape that supports the neck, shoulders, head and/or ears of a user.

### BRIEF DESCRIPTION OF THE DRAWINGS

The above and still further features and advantages of the present disclosure will become apparent upon consideration of the following detailed description of embodiments thereof, especially when taken in conjunction with the accompanying drawings wherein like reference numerals in the various figures are utilized to designate like components, and wherein:

FIG. 1 illustrates various views of a pillow in accordance with the disclosed subject matter;

FIG. 2 illustrates a perspective view and a rear view of a pillow in accordance with the disclosed subject matter;

FIG. 3 illustrates a pillow affixed to a window in accordance with the disclosed subject matter; and

FIG. 4 illustrates a pillow with a channel on the front side in accordance with the disclosed subject matter.

### DETAILED DESCRIPTION

Embodiments of the present invention will be illustrated below in conjunction with exemplary configurations of a window pillow.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The terms “first,” “second,” and the like, herein do not denote an order, quantity, or importance, but rather are used to distinguish one element from another.

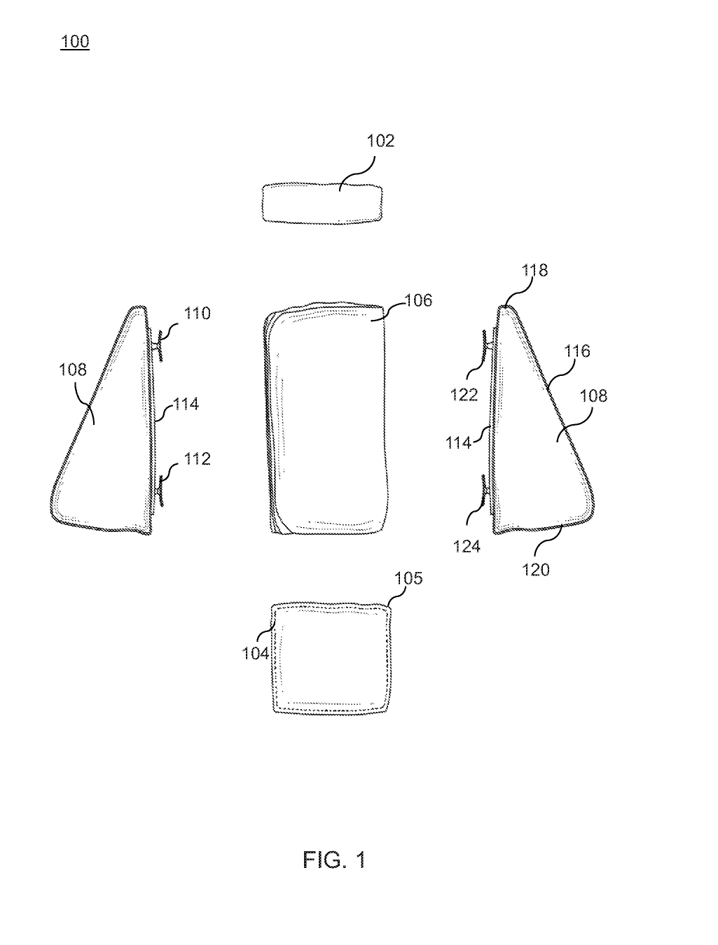

Embodiments of the present invention provide a pillow designed to support the shoulder, neck, head or other body part of a user when resting in a vehicle (e.g., a car, a bus, a train, an airplane, a ship, etc.) during travel. Specifically, the pillow facilitates a relaxing position against a surface by securing the pillow to the surface and naturally comforting the user as it shapes to the shoulder, head or neck of the user. FIG. 1 shows a pillow 100 with a top view, side views, a front view and a bottom view. The pillow 100 is prismatic in shape with a planar rear face 114, a top face 118, a bottom face 120, side faces 108 and an inclining face 116 at the front. The rear face 114 has four suction cups 110, 112, 122 and 124 coupled to it. Each suction cup has a respective concave surface and respective convex surface. The suction cups 110, 112, 122 and 124 secure the pillow 100 to a non-porous surface, not limited to walls, windows of a car, a plane, a train, or a ship. In particular, the concave surface of a suction cup is coupled directly to the non-porous surface, and the convex surface of the suction cup is coupled to pillow 100. In some embodiments the suction cups 110, 112, 122 and 124 are detachable. In some embodiments, there are holes in the planar rear face 114 that allow the suction cups 110, 112, 122 and 124 to be secured onto the back of the pillow 100. The pillow 100 may be used for various purposes, not restricted to usage for resting during travel. The pillow 100 includes one or more cushions 104 enclosed in a cover 105.

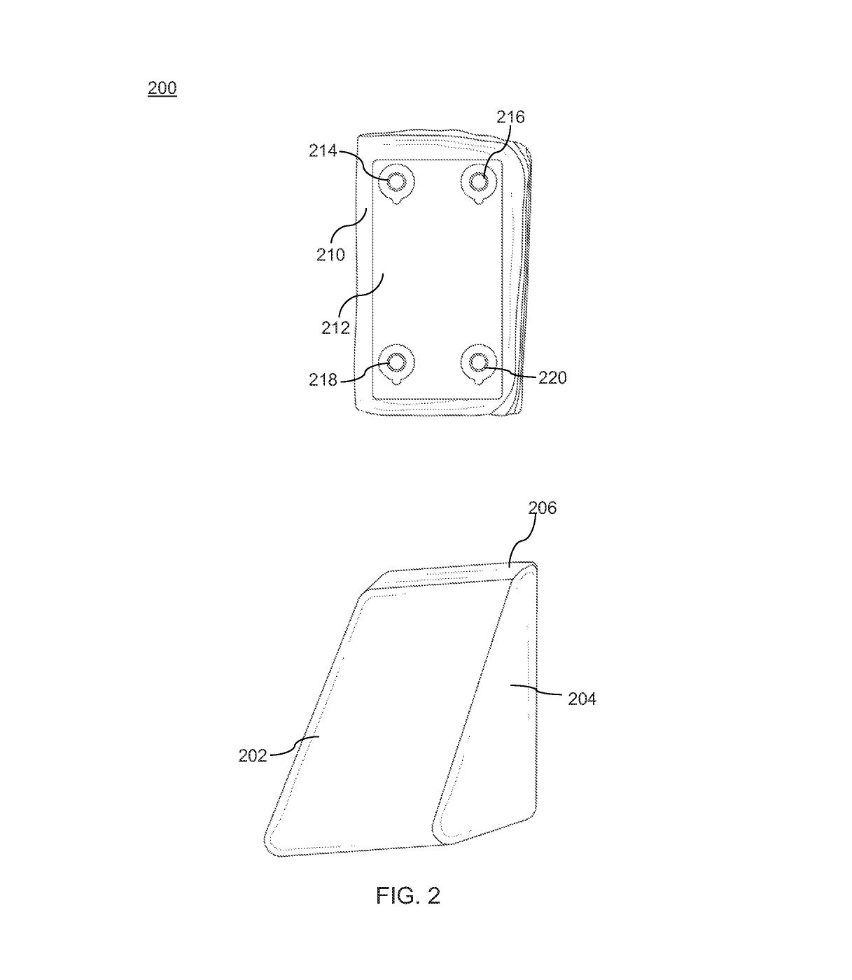

Other embodiments may include either more or fewer than four suction cups, and the suction cups may be distributed in different positions or patterns than that shown in FIG. 1. For example, more suction cups may be provided where the pressure from a body part may be expected to be higher (e.g., under or behind an expected position of a head, in a ring around such an expected position, etc.). In other embodiments, more suction cups may be provided where a suitable surface may be located. For example, if a pillow is to be used in a corner formed between a window (where suction cups are able to adhere) and a seat back (where generally a suction cup is unable to adhere), more suction cups may be located along an edge or surface expected to be in contact with the window. In other embodiments, a suction cup may be removably coupled on its convex side to a rigid board (such as rigid board 212 of FIG. 2), e.g., by way of a hook and loop coupling (e.g., Velcro®) to the rigid board. Such a removable coupling may allow suction cups to be relocated by a user to positions where they would be more effective, for example, where they could adhere best by suction to a surface.

The one or more cushions 104 can consist of an internal filler, that may be made from foam, synthetic fibers, feathers, down, viscoelastic foam (e.g., memory foam), wool, polyester staple fiber, cotton, plastic tubes, Poly-Vinyl Chloride (PVC) pellets, expanded polystyrene, dried beans, expanded polypropylene, or a combination thereof. The internal filler may be an elastic material or granular material, such that the internal filler may redistribute its shape to contour its shape to a body part pressed against it (e.g., a human head weighing about 11 pounds spread over about 12 square inches). The internal filler may substantially retain its shape, or have minor rebound to an original shape, when the body part is no longer pressed against it. The filler is placed in an external casing made of a light material. The cover 105 may be made of wool, silk, cotton or cotton-linen blends. In other embodiments, cover 105 may be made from a material usable for clothing or otherwise neutral or pleasing to the touch, e.g., suede, leather, faux fur, etc. The dimensions and shape of the cover 105 enclosing the one or more cushions are customized to the shape of pillow 100. Some embodiments of the pillow 100 may include embedded electronics functioning as an audio output that may play sounds, voices, and/or music. The pillow 100 may comprise of a trigger or a switch mechanism that enables the playing of audio. Playing of audio may also be triggered by voice activation, pressure-sensitive buttons placed on the pillow 100, detection of motion, smartphone control communicatively coupled by Bluetooth™ or other near-field wireless technology, etc. The trigger is by no means limited to the aforementioned examples and can comprise other mechanisms as well.

Embodiments of the present invention provide a prismatic pillow 200 as shown in FIG. 2. A prismatic shape may be helpful to support the neck and to provide an inclined surface upon which a head can rest. The rear and perspective views of the pillow 200 are shown. The pillow 200 has an inclining face 202 in the front, a rectangular face 210 at the rear, a planar face 204 and another planar face (not seen) on each of the sides, a planar face 206 on the top and a planar base (not shown). A rigid board 212 provides a stiff rectangular shape to the rectangular face 210 enhancing the rigidity of shape at the rear of the pillow 200. The rigid board 212 includes suction cups 214, 216, 218 and 220 that secure the pillow 200 to a non-porous surface by using negative fluid pressure of air to create a partial vacuum. In other embodiments (not illustrated in FIG. 2), a second rigid board may be provided on a side of pillow 200 in order to attach additional suction cups, such that pillow 200 may be secured in a corner, e.g., a corner formed between a window and a seat back.

In some embodiments, a prismatic pillow may have front cross-sectional shapes other than the rectangular front cross-sectional shape of pillow 200. For example, a prismatic pillow may have a circular, elliptical, or other round front cross-sectional shape, such that an inclined front is joined to a vertical rear surface by a continuous sidewall, rather than separate sidewalls such as top face 118, bottom face 120, and side faces 108.

In some embodiments, each of the suction cups 214, 216, 218 and 220 is made of an elastic, flexible material and has a curved face. When a concave side of each of the suction cups 214, 216, 218 and 220 is pressed against a non-porous surface, the volume of the space between each of the suction cups 214, 216, 218 and 220 is reduced, which causes the air between each of the suction cups 214, 216, 218 and 220 and the non-porous surface to be expelled past the rim of each of the suction cups 214, 216, 218 and 220. The pressure difference between the atmosphere on the outside of each of the suction cups 214, 216, 218 and 220 and the low-pressure cavity on the inside of each of the suction cups 214, 216, 218 and 220 keeps the pillow 200 adhered to the non-porous surface.

In some embodiments, the pillow 200 can have fewer suction cups with larger dimensions. In other embodiments, the pillow 200 can have suction cups placed strategically to facilitate a robust adherence to the non-porous surface. For example, the rigid board 212 can include a suction cup in the center. In other examples, suction cups of varying sizes placed at different points on the rigid board 212. The placing of variably-sized suction cups on the rigid board 212 is dependent on the distribution of pressure exerted across the rigid board 212, when a user rests his/her shoulders, head, neck or other body part, such that the pillow 200 adheres to the non-porous surface until the user removes the pillow 200 from the non-porous surface of his/her own volition.

When the user ceases to apply physical pressure to the outside of the suction cup, the suction cup tends to elastically revert to its original, curved surface shape. The length of time for which the suction effect can be maintained depends mainly on how long it takes for air to leak back into the cavity between the suction cup and the surface, equalizing the pressure with the surrounding atmosphere. This depends on the porosity and flatness of the surface and the properties of the suction cup's rim.

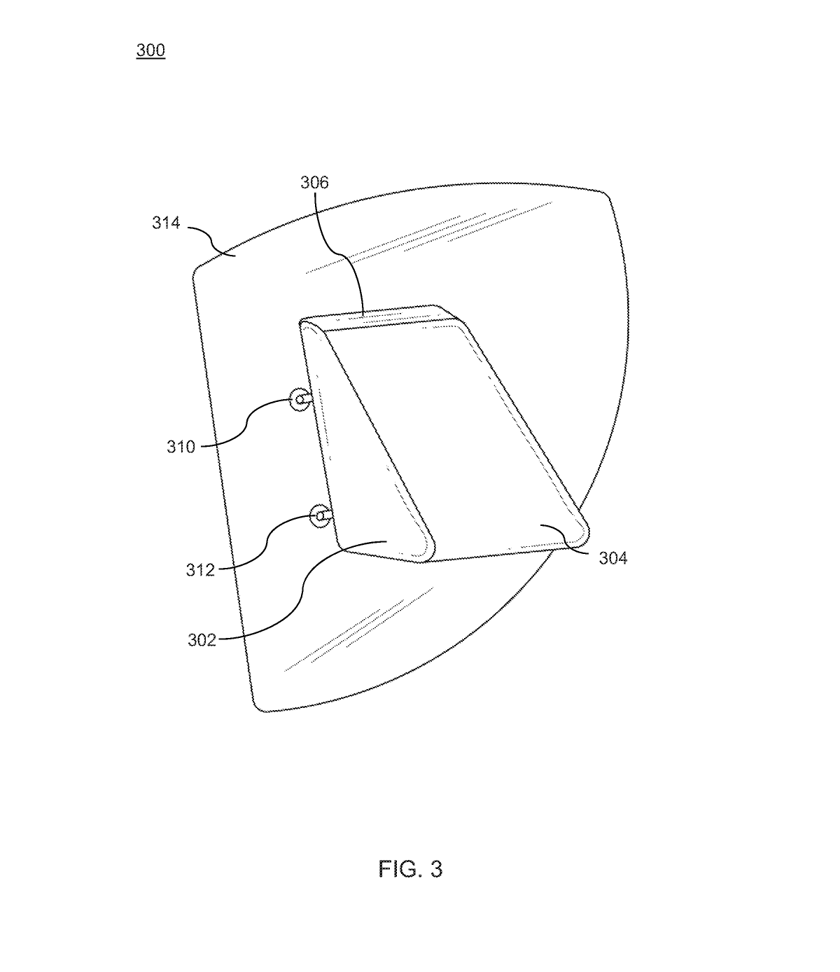

As shown in FIG. 3, embodiments of the present invention include a pillow 300 with an inclined face 304 in the front, a rectangular back at the rear (not seen), a planar face 302 and another planar face (not seen) on each of the sides, a planar face 206 on the top and a planar base (not shown). The rectangular back is supported by a rigid board backing similar to the pillow 200 shown in FIG. 2. The pillow 300 is secured to a non-porous surface 314 through the use of suction cups 310 and 312. In some embodiments, the non-porous surface 314 can be the window of a moving vehicle such as a car, a train, a plane or a ship. In other embodiments, the non-porous surface 314 can be a wall, window in a building or a bed-post to which the pillow can be secured providing a comfortable position to rest.

Referring to FIGS. 2 and 3, both the pillows 200 and 300 include one or more cushions enclosed in a cover as is the case of the pillow 100 (shown in FIG. 1). The one or more cushions include internal filler similar to that of the pillow 100. Further, the pillows 100, 200 and 300 are lightweight, portable and durable.

Alternatively, the cover of the pillow 300, the one or more cushions of the pillow 300 and the suction cups 310 and 312 can be made of an inflatable material such as foam, cotton (e.g., for the cover), plastic, rubber bladder, latex (for the inflatable material), or a combination thereof. A stretchable inflatable material may provide a more pleasing feeling than a non-stretchable inflatable material. The pillow 300 and the suction cups 310 and 312 can be inflated upon usage and deflated when not required.

In some embodiments, the pillow 300 can be folded and stuffed into a pouch. The pillow 300 is adapted to be attached to the non-porous surface 314, which is not restricted to being a car window, a bus window, an airplane window and the like, to provide resting comfort to the head, neck, shoulders and/or other body part of the user. The pillow 300 can be simply placed against the non-porous surface 314 to detachably secure the pillow 300. The pillow 300 can be adapted with various configurations of suction cups, not limited to aforementioned examples pertaining to the pillow 200, as a means of attachment to adhere to the non-porous surface 314. The pillow 300 may also be provided with adjustable attachment means to adjust the pillow height for various users.

In some embodiments, the pillow 300, is designed without an attachment means and is designed to be placed between the user and the non-porous surface 314 wherein the pillow 300 remains situated as a result of the user's weight against it.

In some embodiments, the pillow 300 comprises a plush material and removable exterior covering. Removability facilitates being able to wash the exterior covering, which may be important (or perceived by customers as being important) for a variety of reasons, including but not limited to, health and sanitary reasons, if pillow 300 may be reused by multiple customers, such as from flight to flight aboard an airplane. The removable exterior covering is capable of being matched to the interior of a vehicle, not limited to a car, a plane, a train, a ship and the like, in terms of color and texture, e.g., in order to provide an airline logo or airline color scheme. The pillow 300 is designed to be portable, durable and affordable. The pillow 300 is designed to make resting and sleeping more comfortable for a user eliminating vibrations or jolts incurred during travel.

In some embodiments, the pillow 300 further includes a channel to accept the head, ear, shoulder or other body part of the user for additional comfort. The pillow 300 may be constructed in a variety of shapes. The inside of the pillow may comprise a cushion or, in an alternative embodiment, comprise an inflatable bladder with the inflatable bladder designed for easy storage. The inflatable bladder may be positioned to help form the channel when the bladder is inflated.

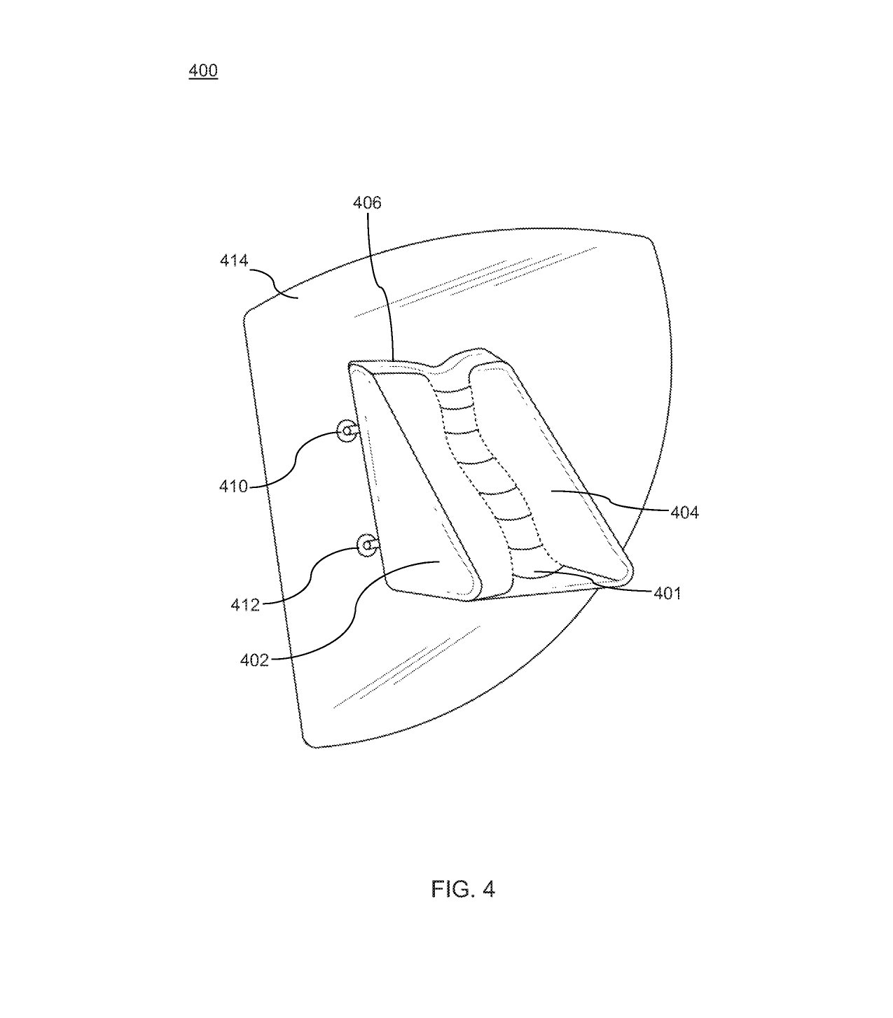

FIG. 4 shows a pillow 400 similar to pillow 300 of FIG. 3. Pillow 400 includes an inclined face 404 in the front, a rectangular back at the rear (not seen), a planar face 402 and another planar face (not seen) on each of the sides, a planar face 406 on the top and a planar base (not shown). The rectangular back is supported by a rigid board backing as the pillow 200. The pillow 400 is secured to a non-porous surface 414 through the use of suction cups 410 and 412. In some embodiments, the non-porous surface 414 can be the window of a moving vehicle, such as a car, a train, a plane or a ship. In other embodiments, the non-porous surface 414 can be a wall, window in a building or a bed-post to which the pillow can be secured providing a comfortable position to rest.

The pillow 400 further includes a channel 401 that is designed for added comfort to accept a portion of a user's body, such as a head, ear, shoulder, neck and the like. The channel 401 may include variable shapes and sizes within the pillow 400 itself. For example, in FIG. 4, the channel 401 is placed in the center of the pillow or is designed to extend along the length of the pillow from top to bottom. Such a vertically-oriented channel may allow a user to adjust vertically how much of pillow 400 is placed under the neck or shoulder blades, while still assuring that the head will be within the channel. A channel should be deep enough to help prevent unwanted head movement as a person rests or sleeps under conditions of a moving car, bus, plane, train, etc. In alternative embodiments, the channel can be designed to extend the length of the pillow from side to side, both top to bottom and side to side, and the like. Such a horizontally-oriented channel may allow a user to keep pillow 400 at an elevated position, above the shoulder blades, with less risk of pillow 400 sliding down. In some embodiments, pillow 400 may be designed to be usable when rotated between a vertically-oriented channel and a horizontally-oriented channel. In the illustrated embodiment, the channel 401 is an indentation extending along the vertical length of the pillow 400 on the front side. The channel also may be formed to contour at least partially to a body shape. For example, a vertically-oriented channel may be relatively wide and deep near an expected location of a head, and relatively narrow and shallow near an expected location of a neck.

In some embodiments, the pillow 400 can be folded and stuffed into a pouch. The pillow 400 is adapted to be attached to the non-porous surface 414, which is not restricted to being a car window, bus window, airplane window and the like, to provide resting comfort to the head, neck and shoulder of the user. The pillow 400 can be simply placed against the non-porous surface 414 to detachably secure the pillow 400. The pillow 400 can be adapted with various configurations of suction cups, not limited to aforementioned examples pertaining to the pillow 200, as a means of attachment to adhere to the non-porous surface 414. The pillow 400 may also be provided with adjustable attachment means to adjust the pillow height for various users.

In some embodiments, the pillow 400 comprises an interior plush material with a removable exterior covering. The removable exterior covering is capable of being matched to the interior of a vehicle, not limited to a car, a plane, a train, a ship and the like, in terms of color and texture. The pillow 400 is designed to be portable, durable and affordable. The pillow 400 is designed to make resting and sleeping more comfortable for a user eliminating vibrations or jolts incurred during travel.

The pillow 400 may be constructed in a variety of shapes. The inside of the pillow may comprise one or more cushions or a plush inside or, in an alternative embodiment, comprise an inflatable bladder with the inflatable bladder designed for easy storage. The pillow 400 includes a cover that is configured to enclose the one or more cushions therein, to form a shape supporting the neck, shoulder or head.

In some embodiments, the pillow 400, is designed without an attachment means and is designed to be placed between the user and the non-porous surface 414 wherein the pillow 400 remains situated as a result of the user's weight against it.

The article presented as part of the invention is not exclusive to the description above. Other related embodiments may be derived in accordance with the principles of the invention described above. Changes within the scope of the disclosed embodiments may be implemented by people skilled in the art.

Generally, embodiments relate to a pillow that provides comfort and support to a user when traveling in an automobile, airplane or like method of travel. However, the advantages of the pillow are not limited to the ones described in the aforementioned embodiments.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use various embodiments of the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of embodiments of the present invention has been presented for purposes of illustration and description. It is not intended to limit embodiments of the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A support pillow, comprising:
a deformable body comprising:
an inclined front face, the front face including a non-planar surface channel contoured to a body part;
a vertical rear face; and
a sidewall to join the inclined front face to the vertical rear face; and
a first suction cup removably coupling the deformable body to a nonporous surface.

2. The support pillow of claim 1, further comprising a rigid board coupled to the vertical rear surface of the deformable body, and coupled to a convex side of the first suction cup.

3. The support pillow of claim 2, wherein the first suction cup is coupled to the rigid board by a hook-and-loop fastener.

4. The support pillow of claim 1, further comprising a removable cover enclosing the deformable body.

5. The support pillow of claim 1, wherein the non-planar surface channel comprises a vertical channel running along the height of the front face.

6. The support pillow of claim 1, wherein the non-planar surface channel comprises a horizontal channel running along the width of the front face.

7. The support pillow of claim 1, wherein the non-planar surface channel comprises a depression contoured to match a human head.

8. The support pillow of claim 1, further comprising electronics functioning as an audio output embedded within the deformable body.

9. The support pillow of claim 1, further comprising an inflatable member embedded within the deformable body.

10. The support pillow of claim 1, wherein the deformable body comprises a foam body.

11. The support pillow of claim 1, wherein the deformable body comprises a member enclosing a granular material.

12. The support pillow of claim 1, wherein the deformable body comprises a plush material.

13. The support pillow of claim 1, further comprising a second suction cup coupled to a different surface of the support pillow than the first suction cup.

14. The support pillow of claim 1, wherein the support pillow is foldable for storing.

15. The support pillow of claim 1, wherein the support pillow has a non-rectangular cross-sectional shape when viewed from a front of the support pillow.
